(19) United States
(12) Patent Application Publication
(10) Pub. No.: US 2006/0083203 A1
(43) Pub. Date: Apr. 20, 2006

(54) Method of successively providing packet data service in a dual-mode mobile communication terminal

(76) Inventor: Woo-Sic Han, Anyang-si (KR)

Correspondence Address: MORGAN & FINNEGAN, L.L.P., 3 World Financial Center, New York, NY, 10281-2101, US

(21) Appl. No.: 11/227,534

(22) Filed: Sep. 14, 2005

(30) Foreign Application Priority Data
Oct. 20, 2004 (KR) 2004-83907

(51) Int. Cl. H04B 7/216

(52) U.S. Cl. 370/335

(57) ABSTRACT

Disclosed herein is a method of successively providing/receiving packet data service in a dual-mode mobile communication terminal. The dual-mode mobile communication terminal activates a Code Division Multiple Access (CDMA) modem when a request for a change of system connection is received from a Wideband Code Division Multiple Access (WCDMA) system during a packet data call through the WCDMA system, and stores information about the packet data call through the WCDMA system. After all call resources assigned to the WCDMA system have been released, a data call is originated to a stored Uniform Resource Locator (URL) through a CDMA system and the packet data call is resumed when the dual-mode mobile communication terminal connects to the CDMA system.

### BACKGROUND OF THE INVENTION

1. Field of the Invention

The present invention relates generally to a method of successively receiving packet data service in a dual-mode mobile communication terminal and, more particularly, to a method of successively providing packet data service to a mobile communication terminal when the mobile communication terminal moves to a code division multiple access cell while receiving packet data service from a wideband code division multiple access system.

2. Description of the Related Art

A mobile communication terminal that can operate in two modes is referred to as a dual-mode mobile communication terminal. In the present invention, the dual-mode mobile communication terminal refers to a terminal that can operate both in a Code Division Multiple Access (CDMA) network and in a Wideband Code Division Multiple Access (WCDMA) network. However, in the following description, the term “dual-mode mobile communication terminal” may be used to include a triple-mode mobile communication terminal capable of operating in a Global System for Mobile communications (GSM) network as well as CDMA and WCDMA networks, and a multimode mobile communication terminal.

Such a dual-mode mobile communication terminal is equipped both with a Radio Frequency (RF) circuit and a modem for CDMA and with an RF circuit and a modem for WCDMA so as to operate both in the CDMA network and in the WCDMA network.

A user of the dual-mode mobile communication terminal may move into to a cell zone where a CDMA network is a dominated signal provider from a cell zone where a CDMA and WCDMA networks are overlapped while receiving data packets from the WCDMA network.

Conventionally, in such a case, packet data service having been received from the WCDMA network is terminated, and inconvenience arises in that an access procedure for packet data service from a CDMA network must be passed through from the beginning when a user wants to continue to receive the packet data service.

### SUMMARY OF THE INVENTION

Accordingly, the present invention has been made keeping in mind the above problems occurring in the prior art, and an object of the present invention is to provide a method of successively providing packet data service when a mobile communication terminal moves to a CDMA network while receiving packet data service from a WCDMA network.

In order to accomplish the above object, the present invention provides a method of successively providing packet data service in a dual-mode mobile communication terminal, in which the dual-mode mobile communication terminal activates a CDMA modem when a request for a change of system connection is received from a WCDMA system during a packet data call through the WCDMA system, and stores information about the packet data call through the WCDMA system. After all call resources assigned to the WCDMA system have been released, a data call is originated to a CDMA system using the stored information and the packet data call is resumed when the dual-mode mobile communication terminal connects to the CDMA system.

The request for the change of system connection is transmitted by the WCDMA system when information about the intensity of a WCDMA signal transmitted to the WCDMA system at regular intervals fulfills a predetermined requirement as the result of an analysis of the intensity of the WCDMA signal. Meanwhile, the information about the intensity of the WCDMA signal may be transmitted at regular intervals only when the intensity of the WCDMA signal is below a predetermined level.

In the meantime, the information about the packet data call through the WCDMA system includes information about a URL that was last accessed by the WCDMA system. In this case, the data call is originated to the URL that was last accessed by the WCDMA system.

Meanwhile, it is preferable to allow the WCDMA modem to make transition to an inactivated state after the release of the resources related to the connection to the WCDMA system.

In addition, the present invention provides a method of successively providing packet data service in a dual-mode mobile communication terminal, including a first step of the dual-mode mobile communication terminal transmitting information about the intensity of a WCDMA signal to a WCDMA system during a packet data call through the WCDMA system; a second step of the WCDMA system, having received the information about the intensity of the WCDMA signal, determining whether the intensity of the WCDMA signal fulfills a predetermined requirement and transmitting a request for a change of system connection to the dual-mode mobile communication terminal if the intensity of the WCDMA signal fulfills the predetermined requirement; a third step of the dual-mode mobile communication terminal, having received the request for the change of system connection, activating a CDMA modem and storing information about a connection to the WCDMA system; a fourth step of the WCDMA system and the dual-mode mobile communication terminal releasing resources assigned to the current packet data call; a fifth step of the dual-mode mobile communication terminal originating a data call to the CDMA system using the information about the connection to the WCDMA system, which was stored in the third step; and a sixth step of the dual-mode mobile communication terminal performing a packet data call through the CDMA system.

The first step may be performed at regular intervals, or at regular intervals only when the intensity of the WCDMA signal is below a predetermined level.

In the meantime, the predetermined requirement is that the intensity of the WCDMA signal be maintained below the predetermined level for longer than a predetermined period of time, that the intensity of the WCDMA signal continuously decrease below a predetermined level, or that the intensity of the WCDMA signal simply decrease to a predetermined level.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram showing the elements of a dual-mode mobile communication terminal for dual-mode operation;

FIG. 2 is a diagram showing the movement of the mobile communication terminal from a cell where WCDMA and CDMA overlap to a CDMA cell;

FIG. 3 is a flowchart showing a process of successively providing packet data service in the dual-mode mobile communication terminal in accordance with the method of the present invention; and

FIG. 4 is a flowchart showing a process in the dual-mode mobile communication terminal.

### DETAILED DESCRIPTION OF THE INVENTION

Reference now should be made to the drawings, in which the same reference numerals are used throughout the different drawings to designate the same or similar components.

With reference to the accompanying drawings, preferred embodiments of the present invention are described in detail.

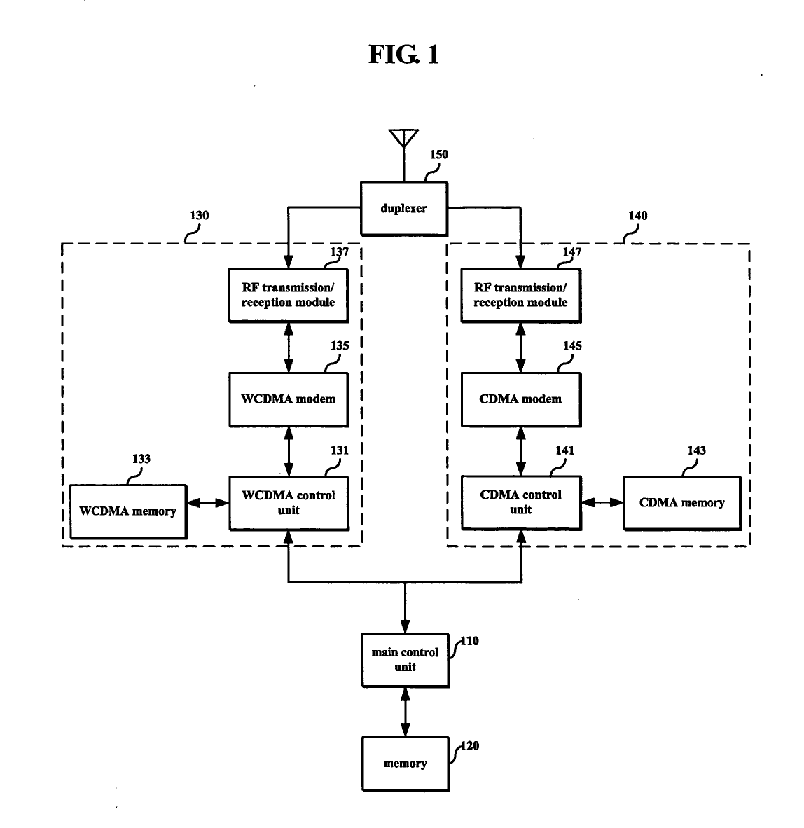

FIG. 1 is a schematic block diagram showing the construction of the elements of a dual-mode mobile communication terminal used in the present invention related to the interface between a WCDMA system and a CDMA system.

The dual-mode mobile communication terminal includes a WCDMA circuit unit 130 for operating in conjunction with a WCDMA system and a CDMA circuit unit 140 for operating in conjunction with a CDMA system. The dual-mode mobile communication terminal further includes a main control unit 110 for controlling operation in the two modes and memory 120 for storing program code and data required by the main control unit 110. The two circuit units 130 and 140 are connected to an antenna through a duplexer 150. In general, the two circuit units 130 and 140 are not all activated at the same time, and the duplexer 150 functions to separate the transmission and reception signals of each of the circuit units.

The two circuit units 130 and 140 each include an RF transmission and reception module 137 or 147, a modem 135 or 145, a control unit 131 or 141, and memory 133 or 143. These elements may be separately implemented using a plurality of Integrated Circuit (IC) chips or Monolithic Microwave ICs (MMIC), or may be integrally implemented using one or several chips. Furthermore, it is possible to integrate RF transmission and reception modules into a single body so that the CDMA circuit part and the WCDMA circuit part can share them.

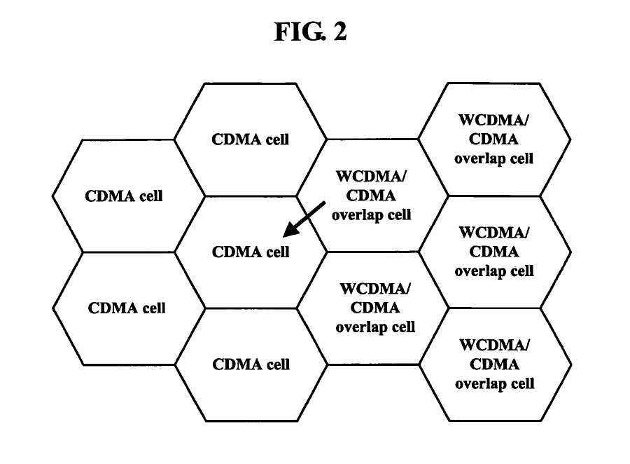

Meanwhile, packet data service has been widely received using mobile communication terminals. Accordingly, as shown in FIG. 2, the case where a mobile communication terminal moves to a CDMA network while receiving packet data service from a WCDMA network frequently occurs. Conventionally, a new procedure is required to continuously receive packet data service through the CDMA network cell after moved in from the WCDMA network cell.

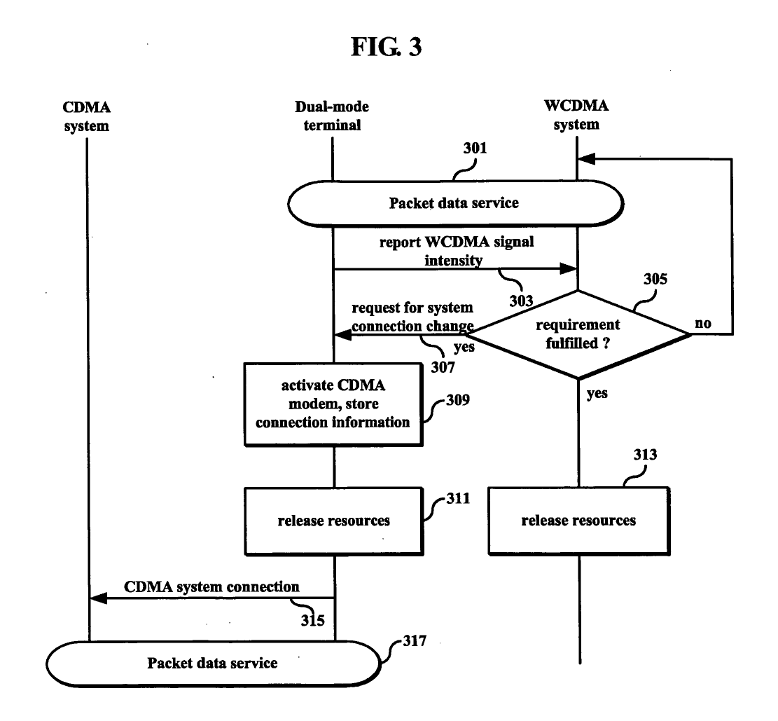

FIG. 3 is a flowchart showing a process of successively providing packet data service to a dual-mode mobile communication terminal between the CDMA and WCDMA systems in accordance with the method of the present invention.

While the dual-mode mobile communication terminal receives packet data service from a WCDMA system at step 301, the dual-mode mobile communication terminal transmits information about the intensity of a WCDMA signal to the WCDMA system at step 303. It is possible for step 303 to be performed at regular intervals, or at regular intervals only when the intensity of a WCDMA signal is lower than a predetermined level.

The WCDMA system, having received the information about the intensity of a WCDMA signal from the dual-mode mobile communication terminal, determines whether the dual-mode mobile communication terminal is about to move out of a WCDMA area by analyzing the information about the intensity of a WCDMA signal at step 305. The determination can be performed by determining whether the received information about the intensity of a WCDMA signal fulfills a predetermined requirement for requesting the system connection change. The predetermined requirement may be that the intensity of a WCDMA signal be maintained below a predetermined level for a predetermined period of time, that the intensity of a WCDMA signal continuously decreases below a predetermined level, or that the intensity of a WCDMA signal simply decrease to a predetermined level. However, the present invention is not limited to a specific requirement.

If the information about the intensity of a signal received from the dual-mode mobile communication terminal does not fulfill the predetermined requirement, the packet data service from the WCDMA system continues. If, however, the information about the intensity of a signal fulfills the predetermined requirement, the WCDMA system transmits a message to the dual-mode mobile communication terminal requesting a change of system connection at step 307.

The dual-mode mobile communication terminal, having received the change of system connection request message, activates the CDMA modem 145 and stores information about the currently ongoing connection to the WCDMA system at step 309. The information about the connection to the WCDMA system may be the Uniform Resource Locator (URL) of a website that was last accessed. Furthermore, the dual-mode mobile communication terminal releases resources related to the connection to the WCDMA system at step 311. In a similar way, the WCDMA system terminates the packet data service between the dual-mode mobile communication terminal and the WCDMA system by releasing resources related to the dual-mode mobile communication terminal at step 313.

When the CDMA modem is activated, the dual-mode mobile communication terminal connects to a CDMA system using the information about the connection to the WCDMA system stored at step 309 and originates a call for packet data service at step 315. For example, the dual-mode mobile communication terminal originates a data call to the URL of the website last accessed. Through the above-described procedure, the dual-mode mobile communication terminal enters a packet data service state via the CDMA system at step 317.

With the features of the present invention as described above, when the dual-mode mobile communication terminal moves from a WCDMA area to a CDMA area while having a packet data call through the WCDMA system, the dual-mode mobile communication terminal automatically reconnects to the website to which the dual-mode mobile communication terminal was connected via the WCDMA system via the CDMA system without the user's manipulation.

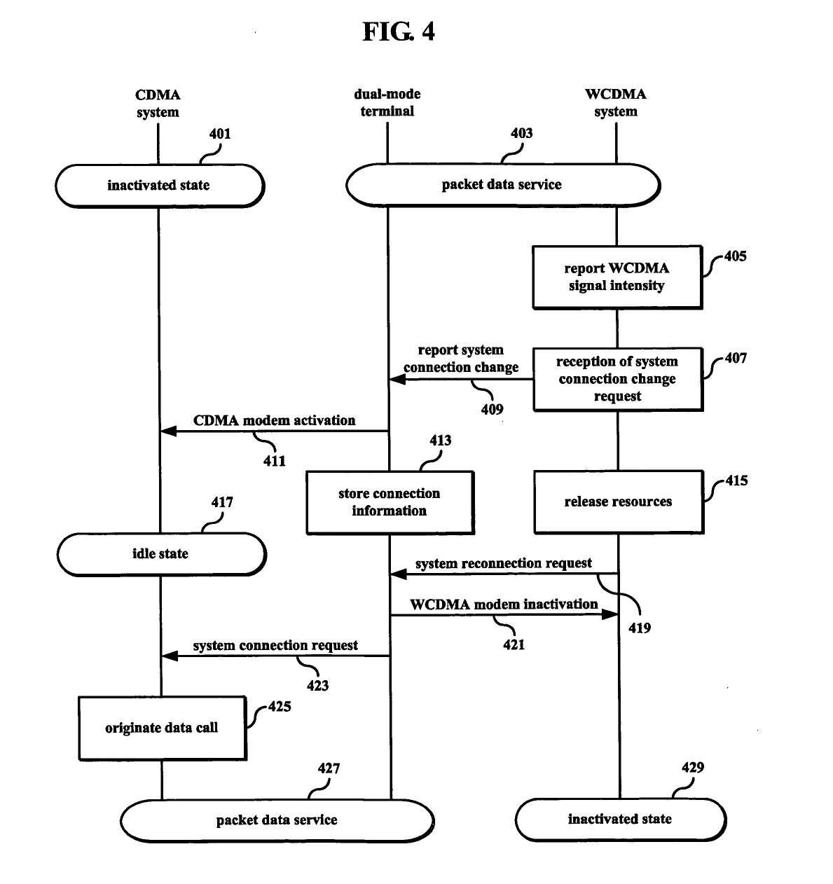

The operation of the dual-mode mobile communication terminal performed in the process as shown in FIG. 3 is described with reference to FIG. 4.

While the dual-mode mobile communication terminal makes a packet data call via the WCDMA network, the CDMA circuit unit 140 remains inactivated at step 401 and the main control unit 110 and the WCDMA circuit unit 130 remain in a packet data service state at step 403. In this state, the WCDMA circuit unit 130 transmits information about the intensity of a WCDMA signal to the WCDMA system at regular intervals at step 405. It is possible for step 405 to be performed only when the intensity of a WCDMA signal is below a predetermined level.

When the dual-mode mobile communication terminal is about to move out of a WCDMA area while the dual-mode mobile communication terminal makes a packet data call via the WCDMA network, the intensity of a WCDMA signal decreases, and the WCDMA system transmits a message to the dual-mode mobile communication terminal requesting a change of system connection. When receiving the requesting message to change the system connection at step 407, the WCDMA circuit unit 130 reports this to the main control unit 110 at step 409.

The main control unit 110, having received the requesting message of changing the system connection, activates the CDMA modem at step 411, and stores the information about the connection to the WCDMA system in the memory 120 at step 413. The information about the connection to the WCDMA system may include the URL of the website that was last accessed by the dual-mode mobile communication terminal. Meanwhile, the WCDMA circuit unit 130 releases resources related to the connection to the WCDMA system at step 415. When the release of resources is completed, the WCDMA circuit unit 130 transmits a message requesting a system re-connection to the main control unit 110 at step 419, and the main control unit 110 having received the message activates the WCDMA modem at step 421.

During this process, the CDMA circuit unit 140 passes through the steps of initialization and synchronization with the CDMA system and enters into an idle state at step 417. Then, the main control unit 110 requests access to the CDMA system using the information about the connection to the WCDMA system stored in the memory 120 at step 423. For example, the main control unit 110 requests that the CDMA system originate a data call to the URL of the website that was last accessed by the dual-mode mobile communication terminal through the WCDMA system. Then, the CDMA circuit unit 140 originates a data call to the URL through the CDMA system at step 425, so that the dual-mode mobile communication terminal can again receive the packet data service, which was received through the WCDMA system, through the CDMA system at step 427.

As described above, in accordance with the present invention, a mobile communication terminal can successively receive packet data service from a CDMA network when the mobile communication terminal moves to the CDMA network while receiving the packet data service from the WCDMA network, through automatic data call origination to the same URL through the CDMA system.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of successively receiving packet data service in a dual-mode mobile communication terminal available for a Wideband Code Division Multiple Access (WCDMA) network and a Code Division Multiple Access (CDMA) network, comprising the steps of:
(1) activating a CDMA modem when a request for a change of system connection is received from a WCDMA system during a packet data call through the WCDMA system;
(2) storing information about the packet data call through the WCDMA system;
(3) releasing all call resources assigned to the WCDMA system;
(4) originating a data call to a CDMA system using the information stored at the step (2); and
(5) resuming the packet data call when the dual-mode mobile communication terminal connects to the CDMA system.

2. The method as set forth in claim 1, wherein the step (1) comprises the steps of:
(1-1) transmitting information about an intensity of a WCDMA signal to the WCDMA system; and
(1-2) activating the CDMA modem when the request for the change of system connection is received from the WCDMA system during the packet data call through the WCDMA system.

3. The method as set forth in claim 2, wherein the step (1-1) is performed at regular intervals.

4. The method as set forth in claim 2, wherein the step (1-1) is performed at regular intervals only when the intensity of the WCDMA signal is below a predetermined level.

5. The method as set forth in claim 1, wherein the information about the packet data call through the WCDMA system includes information about a Uniform Resource Locator (URL) that was last accessed by the WCDMA system.

6. The method as set forth in claim 5, wherein the step (4) is performed in such a way as to originate the data call to the URL that was last accessed by the WCDMA system.

7. The method as set forth in claim 1, further comprising, after the step (3), the step of allowing the WCDMA modem to make transition to an inactivated state.

8. A method of successively providing packet data service in a dual-mode mobile communication terminal, comprising the steps of:
(1) transmitting, from the dual-mode mobile communication terminal, information about an intensity of a WCDMA signal to a WCDMA system during a packet data call through the WCDMA system;
(2) upon receiving the information about the intensity of the WCDMA signal at the WCDMA system, determining whether the intensity of the WCDMA signal fulfills a predetermined requirement and transmitting a request for a change of system connection to the dual-mode mobile communication terminal if the intensity of the WCDMA signal fulfills the predetermined requirement;
(3) upon receiving the request for the change of system connection at the dual-mode mobile communication terminal, activating a CDMA modem and storing information about a connection to the WCDMA system;
(4) releasing resources assigned to the current packet data call at the WCDMA system and at the dual-mode mobile communication terminal;
(5) originating, at the dual-mode mobile communication terminal, a data call to the CDMA system using the information about the connection to the WCDMA system, which was stored in the step (3); and
(6) performing a packet data call through the CDMA system at the dual-mode mobile communication terminal.

9. The method as set forth in claim 8, wherein the step (1) is performed at regular intervals.

10. The method as set forth in claim 8, wherein the step (1) is performed at regular intervals only when the intensity of the WCDMA signal is below a predetermined level.

11. The method as set forth in claim 8, wherein the predetermined requirement is that the intensity of the WCDMA signal be maintained below the predetermined level for longer than a predetermined period of time.

12. The method as set forth in claim 8, wherein the predetermined requirement is that the intensity of the WCDMA signal continuously decrease below a predetermined level.

13. The method as set forth in claim 8, wherein the information about the connection to the WCDMA system includes information about a URL that was last accessed by the WCDMA system.

14. The method as set forth in claim 13, wherein the step (5) is performed in such a way as to originate the data call to the URL that was last accessed by the WCDMA system.

15. The method as set forth in claim 13, further comprising, after the step (5), the step of allowing the WCDMA modem to make transition to an inactivated state.
